(19) United States
(12) Patent Application Publication
(10) Pub. No.: US 2008/0283085 A1
(43) Pub. Date: Nov. 20, 2008

(54) Concrete load cleaning apparatus and method

(76) Inventor: Robert L. Huntsman, Maitland, MO (US)

Correspondence Address: SHUGHART THOMSON & KILROY, PC, 120 WEST 12TH STREET, KANSAS CITY, MO, 64105, US

(21) Appl. No.: 11/803,217

(22) Filed: May 14, 2007

(51) Int. Cl. B08B 3/12

(52) U.S. Cl. 134/1; 134/123; 134/58 R

(57) ABSTRACT

A device and method are provided to allow the removal of unset or generally plastic concrete from the surfaces of mixing and transportation devices by the application of vibrational energy with a liquid to mix and achieve solubilization of the generally plastic concrete into a solution.

### FIELD OF THE INVENTION

The present invention relates to the cleaning and removal of unset or plastic concrete from mixing drums used to mix together concrete and to transport mixed concrete. More particularly, the present invention relates to a means of using vibrational energy to remove concrete residue from mixing drums and to simultaneously mix the concrete residue with a liquid to facilitate the removal of the concrete residue from the drum.

### BACKGROUND OF THE INVENTION

In the course of repeatedly mixing batches of concrete, or repeatedly transporting premixed batches of concrete, it is inevitable that a certain amount of concrete residue is left behind in the mixing device after the bulk of the concrete has been removed from the mixing device for use. Typically, in a stationary concrete mixer, the individual using the device will be more or less successful in removing the concrete residue. Over time, the individual's failure to properly clean the device will only result in the loss of a few thousand dollars worth of equipment. Alternatively, poor cleaning will result in the additional time and expense of chipping out the hardened concrete residue from the stationary mixing device.

In the case of concrete mixer trucks which are used to transport premixed concrete to job sites, the stakes are much higher. A concrete mixer truck will cost many tens of thousands of dollars and must be kept in continuous service to pay for its purchase price. When a batch of concrete or concrete residue sets within the mixing drum of the truck, substantial down time is incurred while the set concrete is chipped from the interior of the mixing drum.

The need to remove concrete buildup from the interior of ready mix concrete truck mixing drums is, to a certain degree, an unavoidable fact within the concrete ready mix industry. Over time, the use of the truck to transport loads of concrete will result in a certain amount of concrete residue build up within the drum. This buildup must be removed as it takes up unnecessary space within the drum, adds unprofitable weight to the weight of the concrete truck and, if left unattended, will reduce the quantity of concrete that can be hauled within the drum. Further, the concrete truck burns more fuel, suffers greater wear and tear on the hydraulic systems and unloads the concrete more slowly.

Concrete truck owners confront this issue continually and are required to periodically take a truck out of service and to reduce the residue buildup within the truck. Removing residue buildup is not only a financial loss for the truck owner in terms of the truck being out of service, but also a financial loss in the additional cost that must be paid to have an individual descend into the concrete mixing drum and manually chip the hardened concrete from the interior surfaces of the drum. The chipping away of the concrete literally results in hammering on the drum and can result in wear and tear to the drum structure and unsightly dents and dings in the drum.

It will further be appreciated that excess buildup of concrete residue within the drum causes wear and tear on inner hydraulic systems as well as the mixing fins within the drum. However, it will be appreciated that failure to remove the excess concrete buildup can result in overweight fines levied against the truck by departments of transportation as drivers attempt to carry a full load of premixed concrete while having the extra weight of set up concrete within the drum. Thus the costs of the excess weight to the premix concrete truck owner resulting from residual concrete now can be appreciated.

### SUMMARY OF THE INVENTION

An apparatus and method are provided which allow more thorough cleaning of concrete mixing drums than has previously been attained. The apparatus comprises a vibration generating device placed in contact with the structure holding a concrete mixer containing unset or generally plastic-state concrete residue and the issuing of vibrational energy through the structure to the wall of the drum to both cause the release of the concrete residue from the drum structures and to mix the concrete residue with an injected stream of liquid.

The method of the present invention comprises the providing of a vibrational energy source and attaching the vibrational energy source in communication with the mixing drum of a concrete mixer truck or stationary concrete mixer to allow vibrational energy created by the vibration generating device to be communicated to the mixing drum. The vibration shakes loose unset concrete residue which is present within the drum and mixes the concrete residue with a fluid which is added into the mixing drum during the method to allow the vibrational energy to mix the concrete residue and the liquid to provide a generally flowable liquid concrete residue solution which may be easily removed from the drum.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a side fragmentary elevation view of a concrete mixer/transport truck having a concrete mixing drum or barrel mounted thereon with a portion of the barrel sidewall removed to reveal the concrete mixing blades or vanes therein having concrete residue thereon; and

FIG. 2 is a fragmentary view of the truck of FIG. 1 taken from below the vibration generator shown in FIG. 1 and showing the vibration generator attached to the chassis of the vehicle and further showing a solenoid for receiving an actuating signal or current from a switch near the discharge opening of the mixer truck for initiating operation of the vibration generator.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

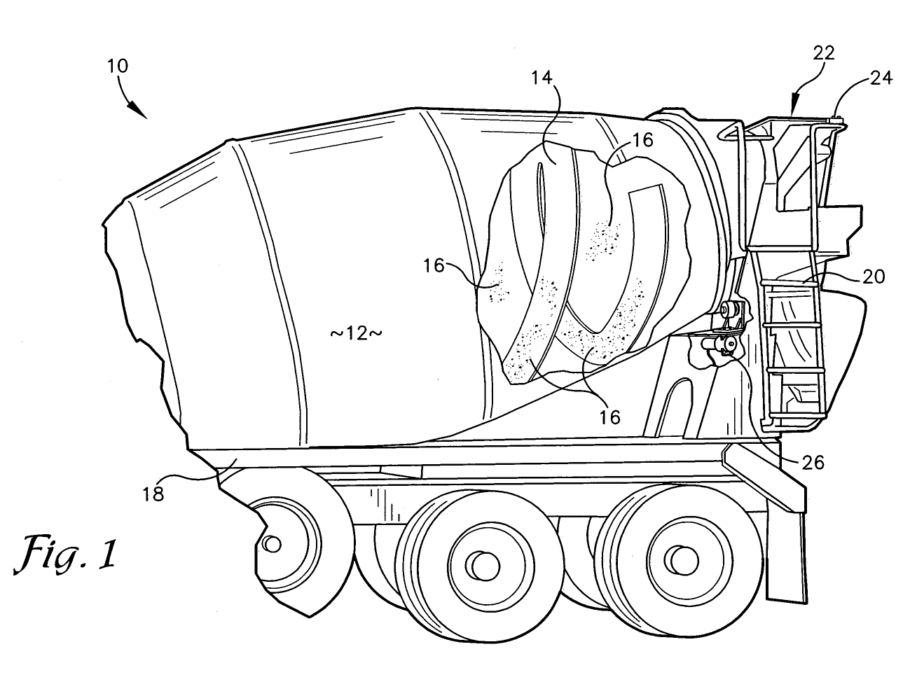

Referring now to FIG. 1, a partial view of a concrete mixing truck 10 is shown in side elevation view with a portion of the side wall of mixing drum 12 removed to reveal mixing blades or mixing vanes 14 within drum 12. As shown in FIG. 1, mixing vanes 14 have concrete residue 16 clinging to vanes 14. Such concrete residue 16, as is shown in FIG. 1, will typically adhere to the mixing vanes 14 of drum 12 and to the interior side walls of drum 12 after a load of concrete has been discharged from the mixing drum 12. It is this concrete residue 16 which is the cause of the problems previously described above.

Still referring to FIG. 1, mixing drum 12 is generally mounted on a truck chassis 18 for transport of the mixing drum to a work site. Chassis 18 is provided with a ladder 20 which allows the operator to ascend to concrete discharge area 22 to observe the cleaning of the interior of mixing drum 12 and to periodically initiate the transmission of vibrations through the mixing drum by the activation of switch 24. Also, while the operator is in position atop ladder 20, the operator can inject water into mixing drum 12 during the cleaning process which shall be described hereinafter.

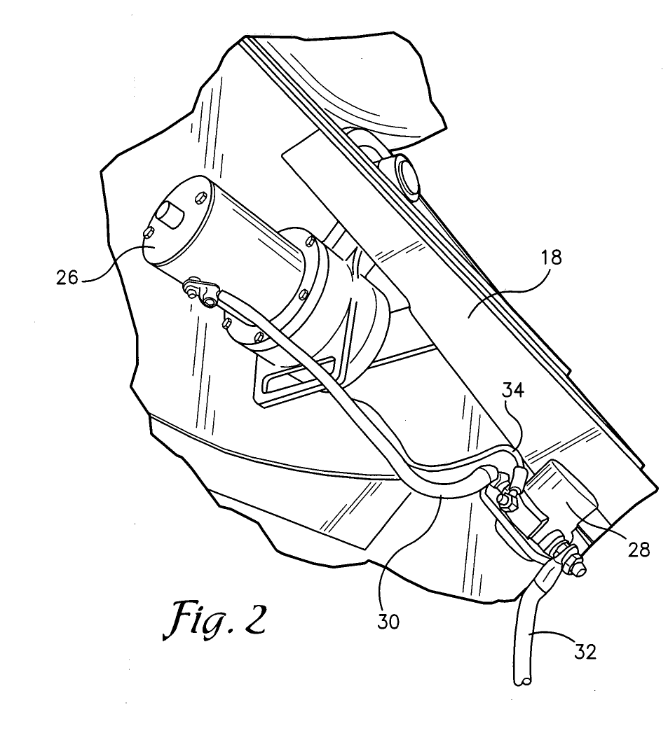

Referring now to FIG. 2, a fragmentary view of chassis 18 is provided showing vibration generation unit 26 mounted on chassis 18. Vibration generation unit 26 is connected to solenoid 28 by conductor 30 so that power from a 12 volt battery which is connected to solenoid 28 by battery conductor 32 is transmitted to vibration generation unit 26 when switch 24 is activated to send a current along switch conductor 34 to close solenoid 28 and to activate vibration generation unit 26.

In a preferred embodiment, vibration generation unit is an electric vibrator which is sized to the purpose by one of ordinary skill in the art. A suitable electric vibrator for a preferred embodiment is made by Global Manufacturing Inc. of Little Rock, Ark., Model CEG-Series 12 Volt DC Electric Vibrator. The vibrator suitable for a preferred embodiment is provided with adjustable force settings so the operator can select the optimum amount of force suitable for the particular mixer and suitable for the particular placement of the vibration generation unit 26 on the mixer chassis 18. It will be appreciated by those skilled in the art that while an electric vibrator is identified as being a part of a preferred embodiment that, alternatively, pneumatic or hydraulic vibrators may be substituted for the electric vibrator of the preferred embodiment. Specifically, in the preferred embodiment, the vibrator generation unit is operated at five thousand rpm to generate 2,100 pounds of centrifugal force for generation of vibrations.

In operation, the vibration generation unit 26 of the preferred embodiment is operated so as to provide vibration or shaking energy and to transmit the vibration through the structure of mixing drum 12 and mixing vanes 14. This results in the physical shaking off and separating of the concrete residue 16 from the inner walls of mixing drum 12 and from mixing vanes 14; and (2) the vibrational mixing of the concrete residue with a liquid which is injected into the mixing drum 12 by the operator during the course of cleaning the mixing drum 12. Specifically, once the truck operator has discharged the load of concrete and pulled away from the unloading point, the operator will then stop the truck and ascend ladder 20 to begin the cleaning operation of the interior of drum 12. The cleaning operation heretofore has generally comprised the rotating of mixing drum 12 while a liquid, such as water, is sprayed into the mixing drum in an attempt to remove the concrete residue from the interior of the drum and mixing vanes 14. In a preferred method embodiment, the operator ascends ladder 20 with the mixing drum rotating in a direction that avoids discharge of the contents. The operator then begins intermittent activation of switch 24 to activate vibration generation unit 26 while also spraying water, or other suitable liquid, into mixing drum 12 to assist in removing concrete residue from the interior surfaces of mixing drum 12 and vanes 14. The injection of the liquid provides a liquid phase for fluidizing the concrete residue as it contacts the injected liquid and is mixed with the injected liquid by the vibrational energy pulsed through mixing drum 12 by the activation of vibration generation unit 26.

As previously described, as the truck operator activates switch 24, current is passed along switch conductor 34 to solenoid 28 to close solenoid 28 to allow power from a battery source to be provided along electrical conductor 30 to vibration unit 26 for electrically powered operation of vibration generation unit 26. Vibration unit 26 then generates vibrations which are passed through chassis 18 to which vibration unit 26 is attached. The vibrations pass through the chassis 18 to mixing drum 12 and to vanes 14 to begin the dislodgement of concrete residue from the side walls and interior of mixing drum 12 and vanes 14. The vibrational energy, which is intermittently pulsed by the truck operator using switch 24, causes the mixing and fluidization of the generally plastic concrete residue 16 and partially dissolves the concrete residue within the fluid or water injected into mixing drum 12 by the operator. In this manner, the concrete residue is dissolved into solution, and the process of the concrete setting is ended. The created slurry of liquid and concrete residue then may be discharged from mixing drum 12 by changing the direction of rotation of mixing drum 12 to the direction of rotation for discharge of material from the mixing drum.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive concrete mixer cleaning method and apparatus are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. A method of cleaning unset concrete residue from a concrete holder portion of a concrete mixing or concrete transport device the method comprising the steps of:
providing a vibration generating device,
attaching said vibration generating device to a concrete mixing or transport device to permit a vibrational energy generated by said vibration generating device to be transmitted to a concrete holder of said mixing or transport device,
generating a vibrational energy by said vibration generating device to,
adding a liquid into the concrete holder, and
allowing said liquid and the unset concrete residue to be mixed by said vibrational energy to render said unset concrete to a flowable state.

2. The method as claimed in claim 1 wherein said liquid is a water based solution.

3. The method as claimed in claim 1 wherein said vibrational energy is generated by an electric vibrator device.

4. The method as claimed in claim 1 wherein said vibrational energy is generated by a pneumatic vibrator device.

5. The method as claimed in claim 1 wherein said vibrational energy is generated by a hydraulic vibrator device.

6. The method as claimed in claim 1 further comprising the step of pulsing intermittently said vibrational energy generator between an operational generator state and a non-operational generator state to provide intermittent pulsed vibrational energy to said concrete holder.

7. An apparatus for removing unset concrete residue from a concrete holder of a concrete mixing or concrete transport device the apparatus comprising:
a concrete mixing or concrete transport device having a concrete holder thereon, said concrete holder having an unset concrete residue therein,
a vibration generating device attached said concrete mixing or transport device for communication of a vibrational energy generated by said vibration generating device to said holder to detach said concrete residue from contact with said concrete holder, and
a liquid for injection into said concrete holder to mix with said unset concrete residue in response to said vibrational energy to provide a liquified solution of said liquid and said concrete residue.

8. The apparatus as claimed in claim 7 wherein said liquid is a water based solution.

9. The apparatus as claimed in claim 7 wherein said vibrational energy is generated by an electric vibrator device.

10. The apparatus as claimed in claim 7 wherein said vibrational energy is generated by a pneumatic vibrator device.

11. The apparatus as claimed in claim 7 wherein said vibrational energy is generated by a hydraulic vibrator device.

12. The apparatus as claimed in claim 7 further comprising an off/on switch connected to said vibrational energy generator for selecting between an operational generator state and a non-operational generator state to provide intermittent pulsed vibrational energy to said concrete holder.
